(19) United States
(12) Patent Application Publication
(10) Pub. No.: US 2026/0341985 A1
(43) Pub. Date: Oct. 29, 2026

(54) Ground Terminal

(71) Applicant: Tyco Electronics AMP Korea Co., Ltd., Gyeongsan (KR)

(72) Inventors: Byung-Hee Cho, Gyeongsan-Si (KR); Sung-Chul Kim, Gyeongsan-Si (KR); Suk-Eun Jung, Gyeongsan-Si (KR); Ki Deok Cheon, Gyeongsan-Si (KR)

(73) Assignee: Tyco Electronics AMP Korea Co., Ltd., Gyeongsan (KR)

(21) Appl. No.: 19/657,112

(22) Filed: Apr. 24, 2026

(30) Foreign Application Priority Data
Apr. 24, 2025 (KR) 10-2025-0053681
Apr. 24, 2025 (KR) 30-2025-0015354
Mar. 5, 2026 (KR) 10-2026-0039908

(51) Int. Cl. H01R 12/58; H01R 4/18

(52) U.S. Cl. CPC H01R 12/585; H01R 4/183

(57) ABSTRACT

A ground terminal includes a body having a lance portion adapted to apply an elastic force to a coupling hole of a coupling target in an outward direction when inserted into the coupling hole of the coupling target. A catch portion that prevents disengagement from the coupling hole is formed on an outer surface of the lance portion. A lever protrudes outward from an upper end of the lance portion and is adapted to be grasped or pressed by a user for inserting or removing the lance portion from the coupling hole. A crimping portion extends from one side of the body. The crimping portion of the terminal is adapted to receive a wire therein for crimping the wire to the terminal.

### CROSS-REFERENCE TO RELATED APPLICATIONS

This application claims the benefit of Korean Patent Application No. 10-2025-0053681, filed on Apr. 24, 2025, Korean Patent Application No. 30-2025-0015354, filed on Apr. 24, 2025, and Korean Patent Application No. 10-2026-0039908, filed on Mar. 5, 2026, in the Korean Intellectual Property Office (now the Ministry of Intellectual Property (MOIP)), the entire disclosures of which are incorporated herein by reference for all purposes.

### FIELD OF THE INVENTION

The disclosure relates to a ground terminal.

### BACKGROUND OF THE INVENTION

In general, in various electrical and electronic products, electrical components are mounted on circuit boards in order to perform various functions of the products. Connection lines for supplying current and transmitting signals may be formed between the respective electrical components. Further, ground terminals may be implemented to prevent a short-circuit condition when overcurrent or overvoltage occurs within the electrical or electronic products.

Once a conventional ground terminal is assembled to a coupling target, such as a printed circuit board (PCB), removal thereof is made difficult. Furthermore, in existing ground terminals, different types of terminals may have to be manufactured, depending on a thickness of a coupling target, a diameter of a wire, and the like.

The above description is information the inventors acquired during the course of conceiving the present disclosure, or already possessed at the time, and was not necessarily publicly known before the present application was filed.

### SUMMARY OF THE INVENTION

According to an embodiment of the present disclosure, a ground terminal includes a body having a lance portion, a catch portion, a lever and a crimping portion. The lance portion is adapted to apply an elastic force to a coupling hole of a coupling target in an outward direction when inserted into the coupling hole of the coupling target. The catch portion adapted to prevent disengagement of the lance portion from the coupling hole is formed on an outer surface of the lance portion. The lever protrudes outward from an upper end of the lance portion so as to be able to be grasped or pressed by a worker or user. The crimping portion extends from one side of the body. The terminal is adapted such that a wire inserted into the crimping portion may be crimped thereby.

### BRIEF DESCRIPTION OF DRAWINGS

The above and other features of the present invention will become more apparent by describing in detail exemplary embodiments thereof with reference to the accompanying drawings, in which:

FIG. 1 is a perspective view illustrating a state in which a ground terminal according to an embodiment is assembled to a printed circuit board (PCB);

FIG. 2 is a cross-sectional view of the ground terminal of FIG. 1 taken along line II-II;

FIG. 3 is a perspective view of the ground terminal of FIG. 1;

FIG. 4 is a perspective view of a ground terminal; and

FIG. 5 is a diagram illustrating a crimping portion of the ground terminal of FIG. 1.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Hereinafter, embodiments are described in detail with reference to the accompanying drawings. However, various alterations and modifications may be made to the embodiments. Here, the embodiments are not meant to be limited by the descriptions of the disclosure. The embodiments should be understood to include all changes, equivalents, and replacements within the idea and the technical scope of the disclosure.

The terminology used herein is for the purpose of describing particular embodiments only and is not to be limiting of the examples. As used herein, the singular form is intended to include the plural forms as well, unless the context clearly indicates otherwise. It will be further understood that the terms “comprises/comprising” or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components regardless of drawing numbers and a repeated description related thereto will be omitted. In the description of embodiments, detailed description of well-known related technology will be omitted when it is deemed that such description will cause ambiguous interpretation of the disclosure.

Also, in the description of the components, terms such as first, second, A, B, (a), (b) or the like may be used herein when describing components of the disclosure. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

Components included in an embodiment and components that have common functions will be described using the same names in other embodiments. Unless stated otherwise, the description of any one embodiment may be applied to other embodiments, and the specific description of the repeated configuration will be omitted.

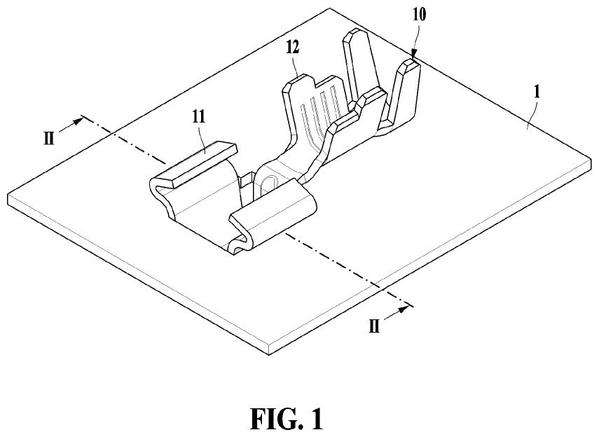

Hereinafter, a ground terminal 10 according to embodiments is described with reference to FIGS. 1-5. Referring to the figures, the ground terminal 10 may include a body 11 and a crimping portion 12. For reference, hereinafter, vertical and horizontal (front-back/left-right) directions are defined with respect to a direction in which the ground terminal 10 is inserted into a coupling hole 1a.

The body 11 may include a piercing, insertion, or lance portion 112 and a lever 111. The lance portion 112 may be inserted into and fixed to the coupling hole 1a formed in a coupling target 1 (for example, a printed circuit board (PCB)). The lever 111 may be formed or adapted (e.g., sized, shaped and positioned) to allow a worker to grasp or apply a force to the lever 111 for rework.

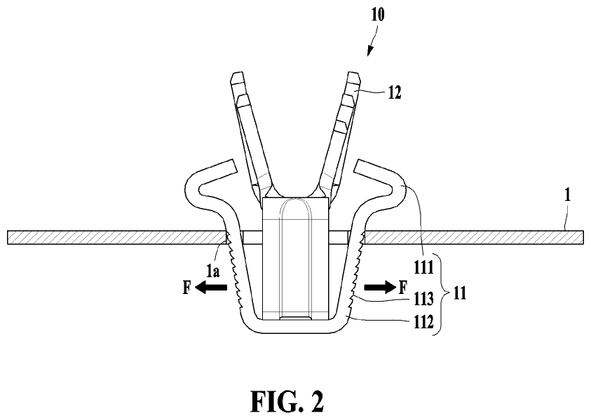

As shown in FIG. 2, the lance portion 112 may be formed by bending the body 11 into an approximately U-shape. In addition, the lance portion 112 may be bent approximately vertically from both ends of the body 11 so as to face each other, and the ends of the lance portion 112 may be formed as free ends to have inherent elasticity. In addition, the lance portion 112 may be formed to gradually spread outward toward an upper direction.

By forming the lance portion 112 in this manner, when the ground terminal 10 is inserted into the coupling hole 1a, the lance portion 112 may apply an elastic force to an inner circumferential edge of the coupling hole 1a, thereby stably maintaining a coupled state. \Furthermore, the lance portion 112 may be inserted into the coupling hole 1a even when the size of the coupling hole 1a varies and may stably maintain the coupled state. In addition, the lance portion 112 may form inclined surfaces that gradually narrow toward the lower side of the lance portion 112 along the direction in which the lance portion 112 is inserted into the coupling hole 1a. Accordingly, when the ground terminal 10 is inserted into the coupling hole 1a, insertion resistance may be reduced and the ground terminal 10 may be easily inserted into the coupling hole 1a.

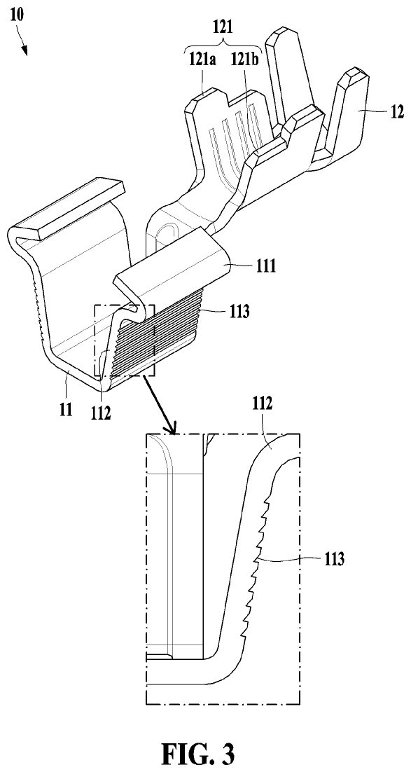

A caught or catch portion may be formed on the outer surface of the lance portion 112 to prevent the lance portion 112 from being separated from the coupling hole 1a. For example, referring to FIG. 3, the caught portion of the lance portion 112 may be serrations 113 formed as an uneven surface, such as serrations formed over the entire outer surface of the lance portion 112. In addition, the serrations 113 may be inclined in a direction that is opposite to a direction in which the lance portion 112 is separated or removed from the coupling hole 1a.

According to embodiments, when the ground terminal 10 is inserted into the coupling hole 1a, the coupled state may be stably maintained by the elastic force applied by the lance portion 112, and separation of the lance portion 112 from the coupling hole 1a may be prevented by the serrations 113. Furthermore, since the ground terminal 10 includes the serrations 113, the ground terminal 10 may be readily applied to the coupling target 1 having various thicknesses.

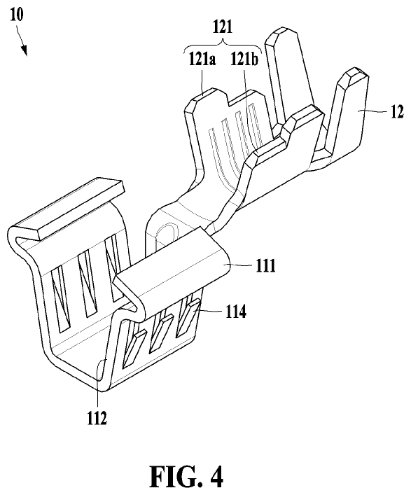

The caught portion of the lance portion 112 may be configured not only as the serrations 113 described above but also, for example, as a locking lance 114 as illustrated in FIG. 4. The locking lance 114 may be formed by cutting a portion of the lance portion 112 and bending the cut portion outward so that the cut portion spreads in the outward direction. At least one locking lance may be formed on each of the opposite side surfaces of the lance portion 112.

In addition, the locking lance 114 may be formed so that, in the insertion direction into the coupling hole 1a, the locking lance 114 gradually extends farther outward from a side surface of the lance portion 112 toward the upper end. As a result, the ground terminal 10 may be inserted into the coupling hole 1a due to elasticity. Once inserted, the ground terminal 10 may engage the edges of the coupling hole 1a to prevent detachment or removal.

The lever 111 may be formed at an upper end of the lance portion 112 and may be bent to protrude outward from the lance portion 112. When rework or removal is required, a worker may grasp the lever 111 or apply a force inward, thereby narrowing the distance between the lever 111 and the lance portion 112. Accordingly, the lance portion 112 and the serrations 113 may be separated from the coupling hole 1a, and the ground terminal 10 may be easily separated from the coupling hole 1a.

The lever 111 may be formed so that a bent portion of the lever 111 has a predetermined thickness to allow a worker to easily grasp or apply a force to the lever 111. A bent outer portion of the lever 111 may be formed as a flat or curved surface. Furthermore, the length of a portion bent toward the inner direction of the ground terminal 10 may be sufficiently short to allow the ground terminal 10 to be separated from the coupling hole 1a when a force is applied to the lever 111. For example, the lever 111 may be bent in an approximately “⊏” shape with respect to an end of the lance portion 112, such that a bent end of the lance portion 112 is positioned approximately on the same plane as the lance portion 112. However, the shape of the lever 111 is only an example, and as long as the lever 111 protrudes outward from the upper end of the lance portion 112 and allows a worker to easily apply force, the lever 111 may be shaped substantially in various ways.

The lever 111 may prevent the ground terminal 10 from being inserted into the coupling hole 1a by engaging with the coupling hole 1a when the ground terminal 10 is being inserted into the coupling hole 1a. That is, the lever 111 may also function as a stopper for limiting an insertion depth of the ground terminal 10 into the coupling hole 1a.

The crimping portion 12 may extend integrally from the body 11 and may be coupled to a wire. The crimping portion 12 may be bent into an approximately “U” shape, and a wire may be inserted into the crimping portion 12 so that a core and a sheath of the wire are crimped and fixed.

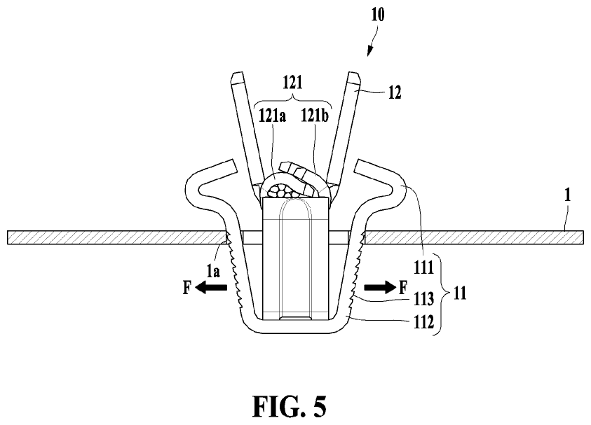

The crimping portion 12 may have steps 121a and 121b formed at both ends 121, or the lengths of the two ends may be different from each other. For example, the ends 121 of the crimping portion 12 may be formed with the steps 121a and 121b so that the lengths of the ends 121 extending from a bent portion differ from one another. In addition, the crimping portion 12 may be formed such that the steps 121a and 121b are staggered relative to each other. In this way, when the crimping portion 12 with the steps 121a and 121b is crimped with a wire inserted, as illustrated in FIG. 5, two-dimensional (2D) crimping may be performed such that the longer and shorter sides of the steps 121a and 121b partially overlap to compress the wire. However, the shape of the crimping portion 12 and the steps 121a and 121b may not be limited to the diagrams and may be modified in various ways. According to this embodiment, because a groove or an uneven surface may be formed on the inner surface of the crimping portion 12 coupled to the wire and a 2D crimping technique is employed, the crimping portion 12 may be applied to wires of various thicknesses or types.

According to embodiments, since the ground terminal 10 includes the lance portion 112 having the caught portion including the serrations 113 or the locking lance 114 formed on the outer surface of the lance portion 112, the ground terminal 10 may be easily applied to the coupling target 1 having various thicknesses. In addition, due to the elastic force of the lance portion 112, the ground terminal 10 may stably maintain a coupled state with the coupling target 1 and may effectively prevent the serrations 113 and the locking lance 114 from being separated from the coupling target 1. Moreover, the ground terminal 10 may include the lever 111, which facilitates rework. Furthermore, since the crimping portion 12 uses the 2D crimping technique, the ground terminal 10 may be easily applied to wires of various thicknesses and types.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

1. A ground terminal, comprising:
a body including:
a lance portion adapted to apply an elastic force to a coupling hole of a coupling target in an outward direction when inserted into the coupling hole of the coupling target;
a catch portion adapted to prevent disengagement from the coupling hole formed on an outer surface of the lance portion; and
a lever protruding outward from an upper end of the lance portion and adapted to be grasped or pressed by a user to at least one of insert or remove the lance portion from the coupling hole; and
a crimping portion extending from one side of the body and adapted to be crimped onto a wire inserted into the crimping portion.

2. The ground terminal of claim 1, wherein the lance portion is formed as a U-shaped body having a base and two ends.

3. The ground terminal of claim 2, wherein the two ends of the body gradually spread outward toward an upper direction.

4. The ground terminal of claim 3, wherein the catch portion includes a serration formed as an uneven surface having a shape inclined in a direction opposite to an insertion direction of the lance portion into the coupling hole.

5. The ground terminal of claim 3, wherein the catch portion includes at least one locking lance formed by cutting and bending a portion of the lance portion outward.

6. The ground terminal of claim 5, wherein the locking lance has a shape inclined in a direction that is opposite to an insertion direction of the lance portion into the coupling hole.

7. The ground terminal of claim 5, wherein the catch portion includes a plurality of the at least one locking lances formed on each of two sides of the U-shaped body.

8. The ground terminal of claim 3, wherein the lever is defined by a bent upper end of each of the two ends of the body.

9. The ground terminal of claim 8, wherein lever extends inwardly from each of two ends of the body.

10. The ground terminal of claim 1, wherein the crimping portion is adapted to crimp a wire using a two-dimensional (2D) crimping technique.

11. The ground terminal of claim 10, wherein the crimping portion is formed with steps at both ends such that lengths of portions extending from bent portions differ from each other.

12. A ground terminal, comprising:
a body having:
a lance portion including a base and two sidewalls, and adapted to be inserted into an opening and retained therein via an elastic force applied by the two sidewalls; and
a catch portion formed on outward-facing sides of the two sidewalls and adapted to prevent disengagement of the lance portion from the opening; and
a crimping portion adapted to be crimped onto a conductor and having a crimping base and two crimping ends extending from each of two sides of the base.

13. The ground terminal of claim 12, wherein the base of the lance portion and the crimping base are offset from one another in a vertical direction of the terminal.

14. The ground terminal of claim 12, wherein the two sidewalls of the lance portion spread outward in an upward direction away from the base.

15. The ground terminal of claim 12, wherein the catch portion include serrations defined on the outward-facing sides of each of the two sidewalls.

16. The ground terminal of claim 15, wherein the serrations have a shape inclined in a direction that is opposite to an insertion direction of the lance portion into the opening.

17. The ground terminal of claim 12, wherein:
the catch portion includes at least one locking lance formed by a bent portion of each of the two sidewalls; and
the locking lance has a shape inclined in a direction that is opposite to an insertion direction of the lance portion into the opening.

18. The ground terminal of claim 12, wherein each of the two crimping ends of the crimping portion are stepped in length such that lengths of portions of each of the two crimping ends differ from one another in a vertical direction.

19. An electrical assembly, comprising:
a circuit board defining an opening; and
a ground terminal, including:
a body having:
a lance portion including a base and two sidewalls, the lance portion inserted into the opening of the circuit board and retained therein via an elastic force applied by the two sidewalls on opposing surfaces defined by the opening; and
a catch portion formed on outer surfaces of the two sidewalls and engaging with the opposing surfaces defining the opening to prevent disengagement of the lance portion from the opening; and
a crimping portion adapted to be crimped onto a conductor.

20. The electrical assembly of claim 19, wherein the body and the crimping portion are offset from one another in a vertical direction such that the crimping portion is adapted to be supported on a top side of the circuit board with the lance portion of the body extending into the opening of the circuit board.
